(19) United States
(12) Patent Application Publication
(10) Pub. No.: US 2008/0288937 A1
(43) Pub. Date: Nov. 20, 2008

(54) ENABLING SOFTWARE SERVICE IN A HOSTED ENVIRONMENT

(75) Inventor: Gerhard J. Waterkamp, Shadow Hills, CA (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/748,587

(22) Filed: May 15, 2007

(51) Int. Cl. G06F 9/445

(52) U.S. Cl. 717/177

(57) ABSTRACT

A method and system are disclosed for providing use of a given software application in a hosted computing environment. This hosted environment includes a host domain including a host server and a host database, and a customer domain including first and second customer servers. The first customer server includes a first suite of software applications, and the host server includes a first instance of a second suite of software applications. The second customer server is provided with a second instance of said second suite of software applications including said given software application. A user inputs data to the host server, and this data are stored in the host database. The given application, on the second customer server, retrieves this data from the host database and inputs the data to the first suite of software applications on the first customer server.

### BACKGROUND OF THE INVENTION

1. Field of the Invention

This invention generally relates to information technology, and more specifically, relates to the use of software applications in a hosted environment.

2. Background Art

The ubiquity of the World Wide Web and the Internet has now enabled companies of every size to take full advantage of the power, simplicity, and flexibility of services-based business computing. What was once known as outsourcing has evolved into today's Software as a Service (SaaS). Today, many companies are choosing to move their applications from Host and Client/Server-based architectures to a Service Oriented Architecture (SOA) in order to reap the benefits associated with the standard and high efficiency brought about by Web- and Internet-based services.

One of the key foundations of the method of Software as a Service is the software service provider. The software service provider is usually a third-party company or organization that hosts applications or services for individuals or businesses. A client can have access to applications by connecting via the Internet or a leaseline to a data center maintained by the software service provider. However, these applications do not need to be installed onto a local server or a personal computer of the client. Thus, owing to the existence of the software service provider, the client can save space of magnetic disk necessary for the installation of applications or services or save expenditure for managing software that can be used for providing his client with advanced services.

Not all applications are designed for use in a hosted environment, though. Some applications are designed for use with certain other applications and might not function seamlessly in a hosted environment.

For example, Oracle Corporation provides a software module, referred to as Siebel Server Sync for Microsoft Exchange Server (SSSE), that facilitates the use of another software application, Microsoft Exchange, provided by Microsoft Corporation. The SSSE helps users centralize information across Microsoft Outlook, and, in particular, helps facilitate the synchronization of Contacts, Calendar, Tasks and Activities between a Siebel Enterprise and Microsoft Exchange. Siebel has designed SSSE for a customer onsite deployment and not for a hosted solution. As a result, companies and other enterprises that have their Siebel Application hosted with a hosting provider are not able to deploy the SSEE module.

### SUMMARY OF THE INVENTION

An object of this invention is to improve hosted computing environments.

Another object of the present invention is to deploy the Siebel Server Sync for Exchange module in a hosted environment.

These and other objectives are attained with a method of and system of deploying an application and database servers as a hosted application in conjunction with certain application modules deployed as part of the customer on site infrastructure.

The method comprises the steps of providing a fully hosted application on the hosting site and then allowing one application component to be installed on the customer site and while acting as part of the customer's infrastructure and security domain, at the same time, being part of the hosted application by allowing this component access to the database of the hosted environment. This way, the application component installed on the customer premise (as part of the customers infrastructure and security domain) has all the necessary access rights to read and write to customer applications required for the synchronization. By having read and write access to the database of the hosted application at the same time, this component can now effectively perform the data synchronization task for the hosted application.

The preferred embodiment of the invention, described in detail below, enables use of SSSE in a hosted environment. Generally, this is achieved by use of an untypical deployment of the Siebel Software. A Siebel Enterprise is a single instance of the Siebel Application with one database and one set of application servers belonging to that Enterprise instance. The solution uses two Siebel Enterprises but pointing both to the same database. The main Siebel Enterprise is the hosted Siebel Customer Resource Management (CRM) application; the second Siebel Enterprise resides on a small server footprint at the customer site and is part of the customer Exchange domain. This Siebel Enterprise installation points to the database at the hosted site and has only the Siebel SSSE module enabled to facilitate the synchronization with Microsoft Exchange.

Further benefits and advantages of this invention will become apparent from a consideration of the following detailed description, given with reference to the accompanying drawing, which specifies and shows preferred embodiments of the invention.

### BRIEF DESCRIPTION OF THE DRAWING

FIG. 1 shows a schematic view of a typical scenario for hosted environments in which the present invention may be practiced.

FIG. 2 shows the schematic overview how the invention is implemented

### DETAILED DESCRIPTION OF THE PREFERRED EMBODIMENTS

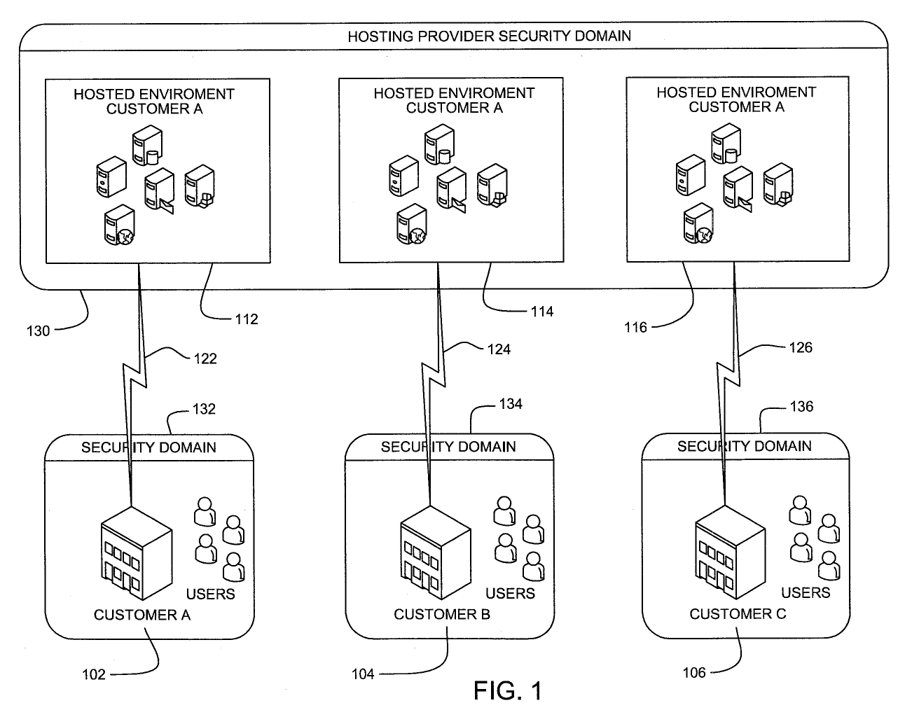

Exemplary methods, systems, and products for practicing embodiments of the present invention are described with reference to the accompanying drawings, beginning with FIG. 1. FIG. 1 sets forth a diagram illustrating an exemplary system for practicing embodiments of the present invention. FIG. 1 shows three customers 102, 104, 106 for a hosting provider with one hosted environment 112, 114, 116 at the hosting provider for each customer. A hosted environment can be made up of mainframe computers, servers datastores and networks that host computer applications on behalf of customers. The hosted systems are managed and maintained by the hosting provider for the customer, while application users on the customer side get access to the hosted application over a communications link 122, 124, 126 that exists between the hosted site and the user location on the customer site. Hosted applications utilize computer resources of the hosted environment, and the owner or operator of the hosted environment (hosting provider) typically charges the customers for such usage.

Types of computer resources so used by hosted applications include, for example, processors, memory, input/output capacity, data stores, database metrics, additional licensed users, operating system modules, application programs, and so on as will occur to those of skill in the art. Types of user computers to which hosted services are provided may include any computing device capable of data communications with the hosted environment, including, for example, personal computers, computer workstations, laptops, mobile telephones, and personal digital assistants.

FIG. 1 also shows security domains. A security domain is a collection of tools, methods, procedures and technology that enables and controls access to a computing environment. Since the hosting provider staff need access for configuration, monitoring, administration and maintenance of the hosted applications, the hosting provider has his own security domain 130 with proper access controls to access all customer environments of this hosting provider. This security domain of the hosting provider is extremely well protected as it enables and controls the access to several customer environments. Having such high security in place is crucial to maintain the security of the applications and data entrusted by their customers. Users of the hosted application get access to their hosted environments over the communication link. This access is enabled with several layers of security to prevent any unauthorized access.

FIG. 1 shows three customers, each with their own security domain 132, 134, 136. The same considerations as discussed above for the hosted security domain apply to the customer owned security domain. The purpose of the customer security domains is to enable and control access to the customers computing systems in a secure way.

As mentioned above, not all software applications are designed for use in a conventional hosted environment. For example, some applications are specifically written for use with other applications. Due to the nature of these applications, a particular one of the former type of applications may not function, or may not function especially well, in a hosted computer environment.

As a more specific example, the Siebel Server Sync for Exchange (SSSE) is a software module facilitating the synchronization of Contacts, Calendar, Tasks and Activities between a Siebel Enterprise and Microsoft Exchange. SSSE, however, is designed for customer onsite deployment and not a hosted solution. As a result, companies that have their Siebel applications hosted with a hosting provider are not able to deploy the Siebel SSSE module.

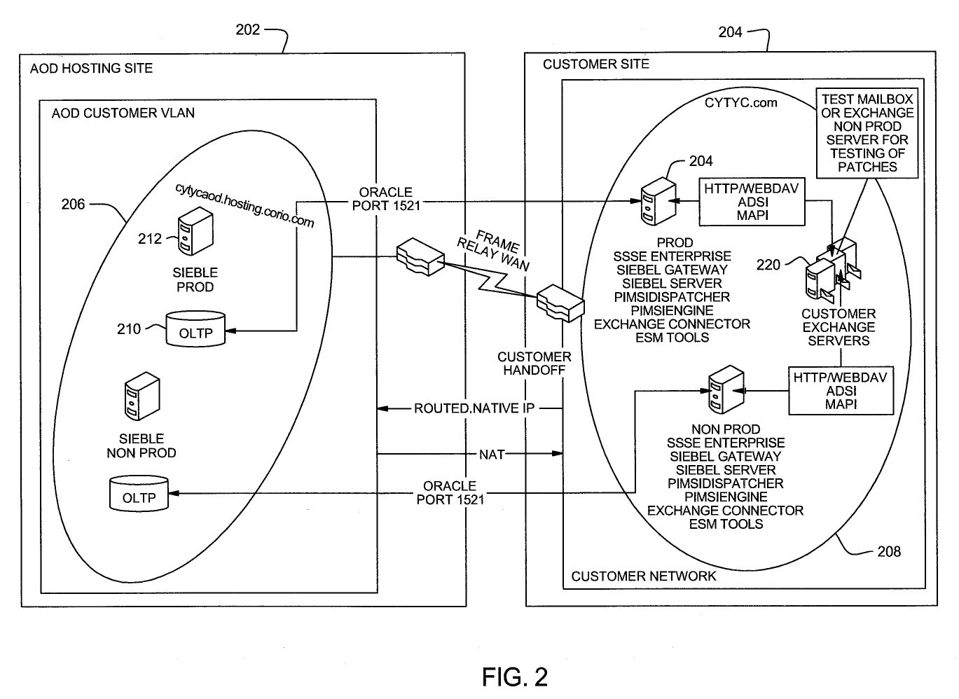

With particular reference to FIG. 2, the preferred embodiment of the present invention enables use of the SSSE in the hosted environment in the above-described situation. Generally, this is achieved by use of a non-typical deployment of the Siebel Software. A Siebel Enterprise is a single instance of the Siebel Application with one database 210 and one set of application servers 212 belonging to that Enterprise instance. The solution uses two Siebel Enterprises but pointing both to the same database 210. The main Siebel Enterprise is the hosted Siebel CRM application; the second Siebel Enterprise resides on a small server 214 footprint at the customer site and is part of the customer Exchange domain. This Siebel enterprise installation points to the database 210 at the hosted site and has only the Siebel SSSE module enabled to facilitate the synchronization with Microsoft Exchange.

In the preferred operation of the invention, the customer hosting Windows 2003 servers 214 on which a complete Siebel Enterprise is installed, but only SSSE components are enabled. These components connect to the hosted Siebel OLTP database 210 and through the Exchange Connector to the Customers Exchange infrastructure 220 performing the synchronization between Contacts, Calendar, Activities and Tasks.

The minimum requirement is to have one Siebel Enterprises at the customer site for Production and Test/QA each. Test/QA is required to apply and test patches, before they are rolled into production.

The smallest installation option is: All Siebel Enterprise components for SSSE on a single 2 way Intel Xcon 3 GHz or better with 4 GB of RAM and 140 GB redundant disk.

Based on sizing, the SSSE Siebel Enterprise can be scaled out by adding additional servers to distribute the workload of the PIMSI Engine across several machines. Additional Siebel Gateway servers or clustering as per standard Siebel architectures can be added to achieve redundancy. Since synchronization is paused in case the SSSE server is down for maintenance or other reasons and resumes gracefully once the SSSE server is brought up again, redundancy might only be required in special situations or high capacity high load situations, where a backed up synchronization can not easily be done.

The arrangement of servers, user computers, network, and other devices making up the exemplary systems illustrated in FIGS. 1 and 2 are for explanation, not for limitation. Data processing systems useful according to various embodiments of the present invention may include additional servers, routers, other devices, client-server and peer-to-peer architectures, not shown in FIGS. 1 and 2, as will occur to those of skill in the art. Networks in such data processing systems may support many data communications protocols, including, for example, TCP/IP, HTTP, WAP, HDTP, and others as will occur to those of skill in the art. Various embodiments of the present invention may be implemented on a variety of hardware platforms in addition to those illustrated in FIGS. 1 and 2.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of or aspects of methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of deploying an application software suite that is designed for an on premise deployment, as a hosted application in a hosted environment, said hosted environment including a hosting site having a host security domain, and a client site having a client security domain, the method comprising the steps of:
installing the application software suite on the hosting site within the security domain of the hosing site;
installing one module of said application software suite on the client site within the security domain of the client site;
providing said one module with full access to resources at the client site to facilitate data communication with a given client application, and at the same time, providing said one module with read and write access to a database of the application software suite installed at and in the security domain of the hosting site; and
using said one module to facilitate data synchronization between the application software suite at the hosting site, and said given application in the security domain of the client site, thus enabling said given application to be operated in the hosted environment.

2. A method according to claim 1, wherein the step of installing one module includes the steps of:
installing a copy of the application software suite on the client site; and
enabling said one module of said copy of the application software suite.

3. A method according to claim 2, wherein the enabling step includes the step of enabling only said one module of said copy of the application software suite.
